(19) United States
(12) Patent Application Publication
(10) Pub. No.: US 2008/0213902 A1
(43) Pub. Date: Sep. 4, 2008

(54) Slide Holder for Staining Procedures

(75) Inventors: Ilia Ichetovkin, Hamden, CT (US); Michael Kilpatrick, West Hartford, CT (US)

Correspondence Address: KELLEY DRYE & WARREN LLP, 400 ALTLANTIC STREET , 13TH FLOOR, STAMFORD, CT, 06901, US

(73) Assignee: Ikonisys, Inc., New Haven, CT (US)

(21) Appl. No.: 11/833,760

(22) Filed: Aug. 3, 2007

Related U.S. Application Data
(60) Provisional application No. 60/821,555, filed on Aug. 4, 2006.

(51) Int. Cl. G01N 31/00; G02B 21/26

(52) U.S. Cl. 436/8; 359/391

(57) ABSTRACT

Improvements in FISH staining employing a microscope slide holder which allows for batch processing of slides in the hybridization process.

### CROSS REFERENCE TO RELATED APPLICATIONS

This application claims the benefit of priority of U.S. Provisional Application No. 60/821,555 filed Aug. 4, 2006 which is incorporated by reference herein in its entirety.

All references cited in this specification, and their references, are incorporated by reference herein where appropriate for teachings of additional or alternative details, features, and/or technical background.

### BACKGROUND OF THE INVENTION

1. Field of the Invention

The present invention generally relates to an apparatus and method for improving FISH staining, in particular when a hydrophobic fluorescent tag is employed.

2. Description of the Related Art

Many methods are known to aid in the microscopic analysis of samples. For example, without limitation, it is known that certain dyes have an affinity for certain cellular structures. Such dyes may therefore be used to aid in analysis by helping to further elucidate such structures.

Fluorescence microscopy of cells and tissues is well known in the art. Treating cells with fluorescent reagents and imaging the cells is well known in the art. Methods have been developed to image fluorescent cells in a microscope and extract information about the spatial distribution and temporal changes occurring in these cells. Some of these methods and their applications are described in an article by Taylor, et al. in American Scientist 80 (1992), p. 322-335. These methods have been designed and optimized for the preparation of a few specimens for high spatial and temporal resolution imaging measurements of distribution, amount and biochemical environment of the fluorescent reporter molecules in the cells. Detection of fluorescent signals may be by way of an epifluorescent microscope which uses emitted fluorescent light to form an image (whereas a conventional reflecting microscope uses scattered illumination light to form an image). The excitation light of a epifluorescence microscope is used to excite a fluorescent tag in the sample causing the fluorescent tag to emit fluorescent light. The advantage of an epifluorescence microscope is that the sample may be prepared such that the fluorescent molecules are preferentially attached to the biological structures of interest thereby allowing identification of such biological structures of interest.

The acronym “FISH” references a technique that uses fluorescein tags that glow under ultraviolet light to detect chromosomal structure. FISH uses fluorescent probes which bind only to those parts of the chromosome with which they show a high degree of sequence similarity. Such tags may directed to specific chromosomes and specific chromosome regions. The probe has to be long enough to hybridize specifically to its target (and not to similar sequences in the genome), but not too large to impede the hybridization process, and it should be tagged directly with fluorophores. This can be done in various ways, for example nick translation and PCR using tagged nucleotides. If signal amplification is necessary to exceed the detection threshold of the microscope (which depends on many factors such as probe labelling efficiency, the kind of probe and the fluorescent dye), fluorescent tagged antibodies or streptavidin are bound to the tag molecules, thus amplifying the fluorescence.

The FISH technique may be used for identifying chromosomal abnormalities and gene mapping. For example, a FISH probe to chromosome 21 permits one to “fish” for cells with trisomy 21, an extra chromosome 21, the cause of Down syndrome. FISH kits comprising multicolor DNA probes are commercially available. For example, AneuVysion Multicolor DNA Probe Kit sold by the Vysis division of Abbott Laboratories, is designed for in vitro diagnostic testing for abnormalities of chromosomes 13, 18, 21, X and Y in amniotic fluid samples via fluorescence in situ hybridization (FISH) in metaphase cells and interphase nuclei. The AneuVysion® Assay (CEP 18, X, Y-alpha satellite, LSI 13 and 21) Multi-color Probe Panel uses CEP 18/X/Y probe to detect alpha satellite sequences in the centromere regions of chromosomes 18, X and Y and LSI 13/21 probe to detect the 13q14 region and the 21q22.13 to 21q22.2 region. The combination of colors evidenced is used to determine whether there is normal chromosome numbers or trisomy. In a similar vein, the UroVysion kit by the Vysis division of Abbott Laboratories designed to detect chromosomal abnormalities associated with the development and progression of bladder cancer by detecting aneuploidy for chromosomes 3, 7, 17, and loss of the 9p21 locus via fluorescence in situ hybridization (FISH) in urine specimens from persons with hematuria suspected of having bladder cancer.

Conventional FISH staining apparatuses and techniques may be less than desirable in terms of the time expended therein. The present invention addresses these and related concerns.

### SUMMARY OF THE INVENTION

Embodiments disclosed herein include:

A microscope slide holder comprising a container comprising at least four walls wherein at least two walls are parallel to each other, the container having a distal end; at least two pivoting mechanisms, each pivoting mechanism mounted to one of said parallel side walls, each pivoting mechanism operable from the exterior of said container; and a plurality of slide-holding shelves, each shelf having a first end and a second end pivotably mounted at the first end and the second end to a pivoting mechanism; such that operation of the pivoting mechanism causes a shelf to reversibly change from a generally horizontal orientation to a generally vertical orientation.

A method of labeling a sample comprising providing a microscope slide holder as described in the preceding paragraph; contacting a sample affixed to a microscope slide with a reagent; placing the labeled slide on a slide-holding shelf of said slide holder wherein the shelf is oriented horizontally in said slide holder; operating said at least two pivoting mechanisms to cause a shelf to be oriented vertically; and immersing said slide holder in a composition that rinses the reagent from the slide.

A microscope slide holder comprising a container comprising at least four walls wherein at least two walls are parallel to each other, the container having a distal end, any two adjoining walls defining a frame axis, a plurality of frame axes being parallel to each other, the container having a distal end; retaining detents incorporated into two opposing parallel walls in equal numbers, oriented to provide slots parallel to a frame axis such that a plurality of slides may be disposed in the slide holder; and at least one limiting bar placed at the distal end of the slide holder.

A method of labeling a sample comprising providing a microscope slide holder such as described in the preceding paragraph; contacting a sample affixed to a microscope slide with a reagent; placing the labeled slide in a slot of said slide holder wherein slide holder is positioned such that the slot is oriented essentially horizontally; and immersing said slide holder in a composition that rinses the reagent from the slide wherein the slide holder is positioned in the composition such that the slot is oriented essentially vertically.

A microscope slide holder comprising:

(a) rotatable horizontal shelves held in parallel to one another in a peon housing frame, the rotatable horizontal shelves operatively configured to hold a plurality of microscope slides in a horizontal manner;

(b) actuation means for rotating in tandem said rotatable horizontal shelves from a horizontal plane to a vertical plane within said housing,

### BRIEF DESCRIPTION OF THE FIGURE

FIG. 1. Embodiment of a microscope slide holder of the invention. Top, perspective view; bottom, view showing the slide holder on its side.

### DETAILED DESCRIPTION OF THE INVENTION

There is disclosed in an embodiment herein a microscope slide holder for improving sample flow through a FISH staining protocol of a multiple number of samples on microscope slides. In certain embodiments the slide holder comprises a housing frame in which a plurality of microscope holding shelves are held in an approximately parallel horizontal fashion to one another at two opposing sides of the frame. The housing frame has rectilinear walls that accommodate the holding shelves at two opposing walls. The housing frame furthermore may be open on a bottom surface, and generally in many embodiments is open at the top. Alternatively the bottom of the housing frame may include a porous mesh, screen or grid that permits liquids to pass freely yet keeps solid objects from passing. The shelves are operatively configured to be pivotable about each point at which they are adjoined to the two opposing sides of the frame and to have structure which firmly holds a microscope slide on the shelves. In such embodiments pivoting of the shelves may be by a pivoting mechanism operatively configured to cause each of the shelves to pivot in tandem when the pivoting mechanism is activated. The shelves, and the slides affixed thereto, may be pivoted from the horizontal plane to a vertical plane, and vice versa, by way of the pivoting mechanism, such that the slides thereon move from a horizontal to a vertical position.

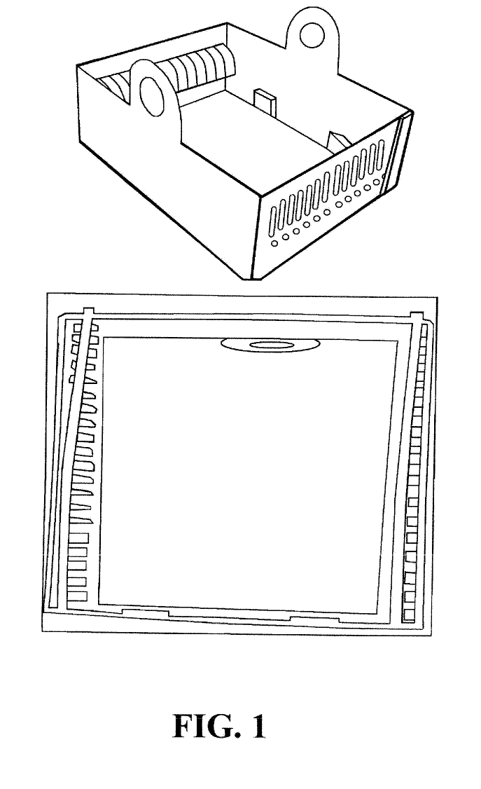

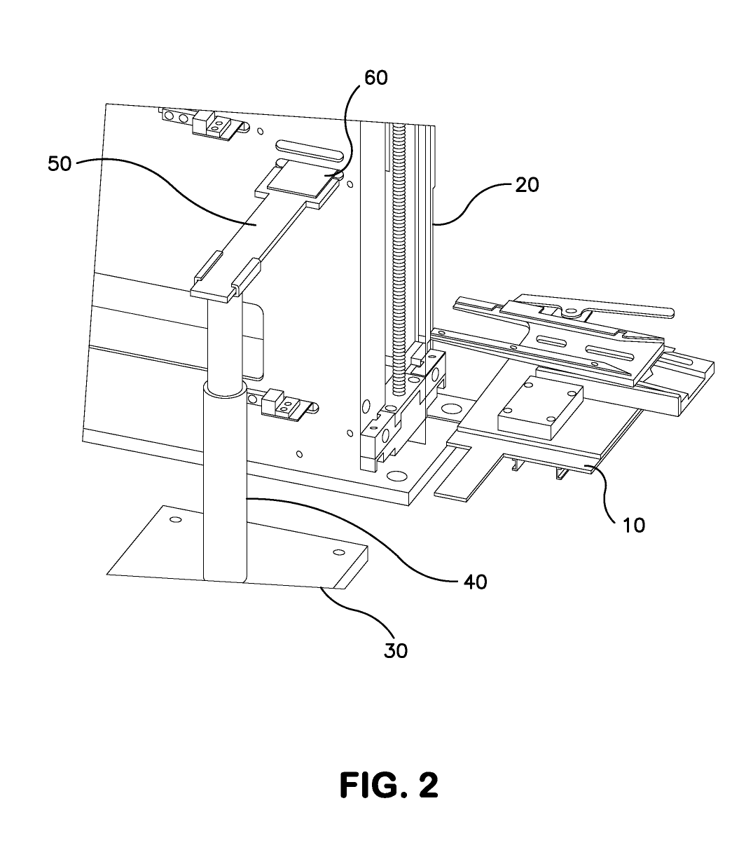

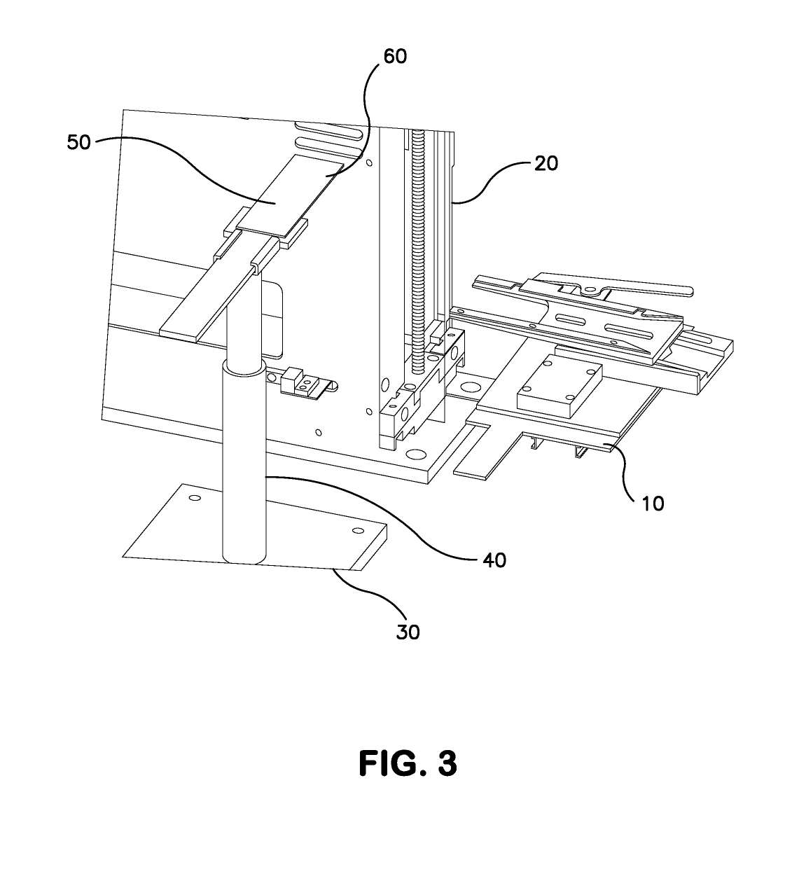

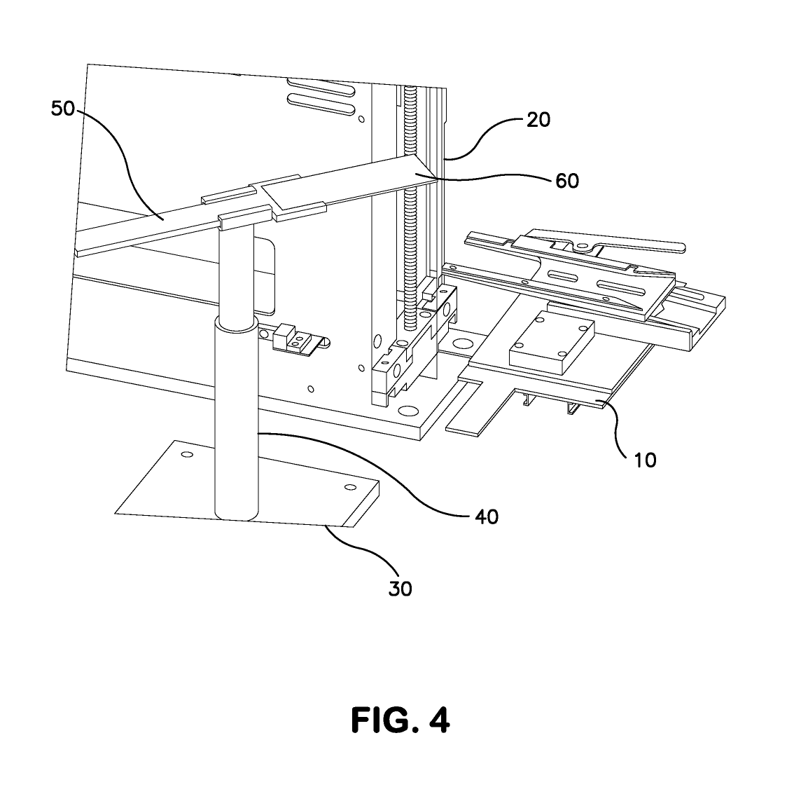

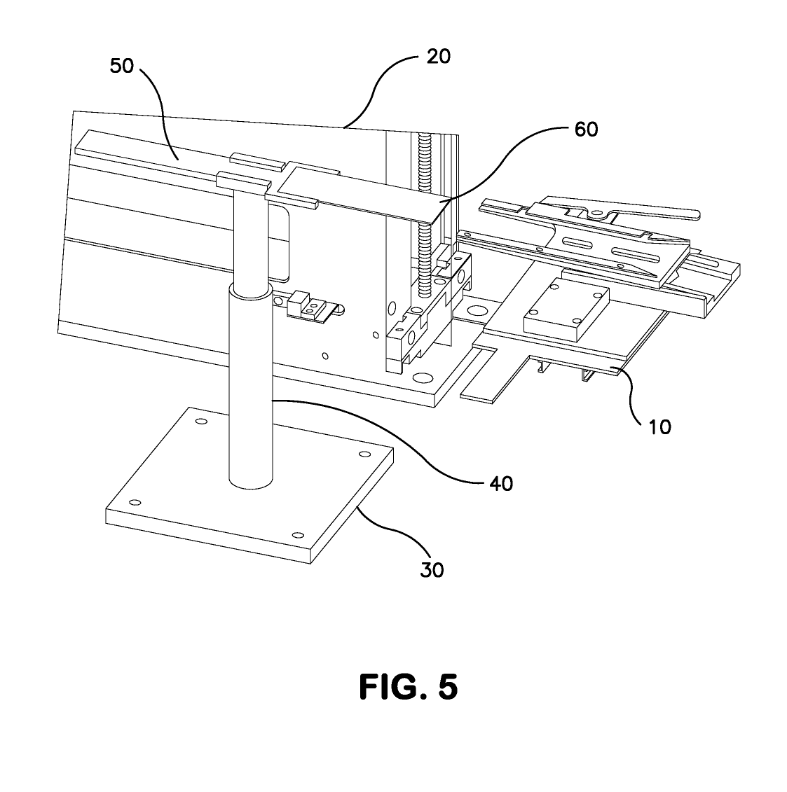

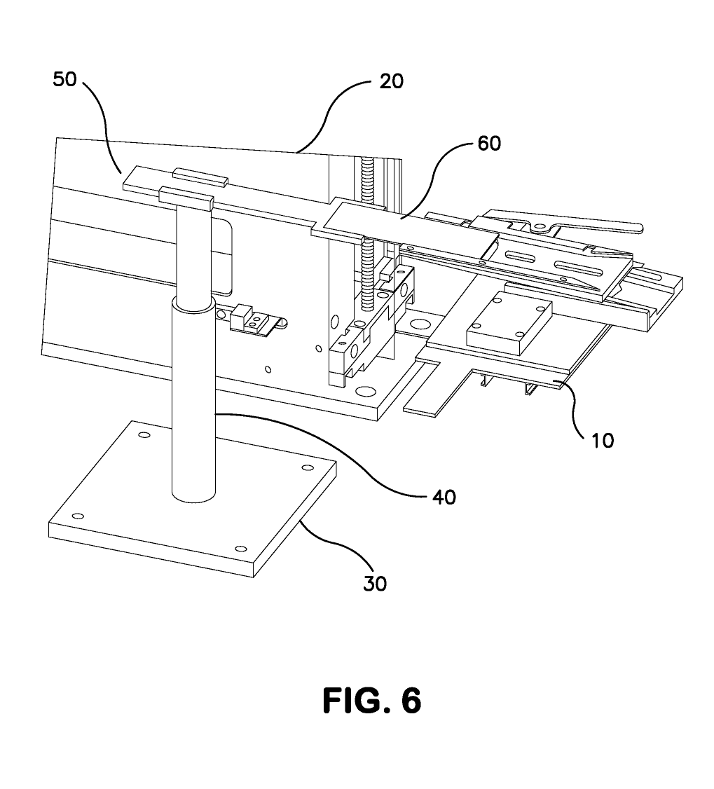

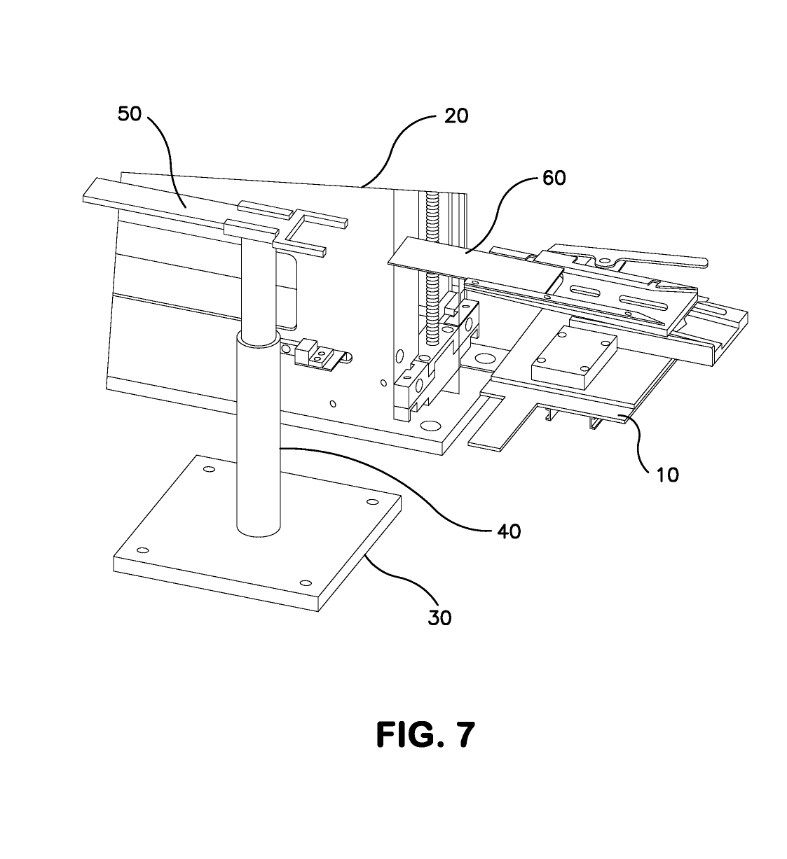

An alternative embodiment of a microscope slide handler is depicted in FIG. 1. The upper panel provides a perspective view. It includes four walls arranged along rectangular coordinates, with an open top and an open bottom. Any two adjoining walls define a frame axis. Two opposing walls have retaining detents incorporated into them in equal numbers, oriented to provide slots parallel to a frame axis such that a plurality of slides may be disposed in the slide holder, with opposite edges of a slide held in correspondingly opposed detents. She plane of a slide, when contained in the holder, is parallel to a frame axis. At least one limiting bar is placed at a distal end of the slide holder to keep a slide from falling through an open bottom of the slide holder (FIG. 1, lower panel).

When the slide holder is oriented such that a frame axis, and the slides contained within the holder, are vertical (FIG. 1, upper panel), the holder may be immersed in a suitable vessel containing a fluid composition, in order to contact all the slides simultaneously with the composition. Removing the holder from the vessel causes the composition to drain from the slides. Furthermore, if the slides have non-fixed cover slips attached, immersing the slide holder in a vessel containing a fluid may be used to rinse off the cover slips from the slides.

When the slide holder is oriented such that a frame axis, and the slides contained within the holder, are horizontal (FIG. 1, lower panel), any composition applied to a sample or specimen disposed on the slide remains in contact with the sample or specimen until deliberately removed. In an exemplary procedure, a reagent composition, such as one that is expensive and is to used sparingly, may be applied directly on the sample or specimen in low volume. The reagent reacts or interacts with the sample or specimen, and the sample or specimen may, if desired, be covered with a cover slip. By way of nonlimiting example, a probe for use in a FISH assay may be applied in this way. In particular, since the slide holder contains a plurality of slides, after the reagent is applied to each slide, the plurality of slides may be treated or manipulated in unison in the slide holder, thereby providing efficient further handling of the plurality of slides.

Such devices may be advantageously employed in hybridization procedures wherein the cost of the labeled taggant is often high, and therefore the minimum amount of taggant necessary for the protocol is desired to be expended. An exemplary, but not limiting, FISH protocol may entail taking slides with a fixed biological sample thereon, adding small quantities of probe mixture onto the slide followed by cover-slipping. After thermocycling the slides are placed back into the slide holder each on shelve. The slide holder is then placed in bulk into a humidified FISH chamber and hybridization is allowed to proceed, for example, for 10-16 hours at a temperature of about 22-38° C. After each of the slides is adequately prepared, each slide is viewed under the microscope and then replaced after viewing on the appropriate shelf. All of this may be done in an automated fashion. After each slide in the slide holder has been reviewed, then the slides can be cleaned in bulk by placing the slide holder into a solution that allows the cover slips to fall off when the shelves are moved from a first position in which FISH binding occurred to a second position conducive the gravity to help remove the cover slips (e.g. from a horizontal to a vertical plane).

### STATEMENT REGARDING PREFERRED EMBODIMENTS

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

What is claimed is:

1. A microscope slide holder comprising
(a) a container comprising at least four walls wherein at least two walls are parallel to each other, the container having a distal end;
(b) at least two pivoting mechanisms, each pivoting mechanism mounted to one of said parallel side walls, each pivoting mechanism operable from the exterior of said container; and
(c) a plurality of slide-holding shelves, each shelf having a first end and a second end pivotably mounted at the first end and the second end to a pivoting mechanism;
such that operation of the pivoting mechanism causes a shelf to reversibly change from a generally horizontal orientation to a generally vertical orientation.

2. The slide holder described in claim 1 wherein a slide-holding shelf comprises means for reversibly holding a microscope slide to said shelf.

3. The slide holder described in claim 1 wherein a pivoting mechanism is manually operable.

4. The slide holder described in claim 1 wherein a pivoting mechanism is mechanically or electrically operable.

5. The slide holder described in claim 1 wherein the slide holder further comprises a porous screen at the distal end of the container.

6. A method of labeling a sample comprising
(a) providing a microscope slide holder comprising
(i) a container comprising at least four walls wherein at least two walls are parallel to each other, the container having a distal end;
(ii) at least two pivoting mechanisms, each pivoting mechanism mounted to one of said parallel side walls, each pivoting mechanism operable from the exterior of said container;
(iii) a plurality of slide-holding shelves, each shelf having a first end and a second end pivotably mounted at the first end and the second end to a pivoting mechanism;
(b) contacting a sample affixed to a microscope slide with a reagent;
(c) placing the labeled slide on a slide-holding shelf of said slide holder wherein the shelf is oriented horizontally in said slide holder;
(d) operating said at least two pivoting mechanisms to cause a shelf to be oriented vertically; and
(e) immersing said slide holder in a composition that rinses the reagent from the slide.

7. A microscope slide holder comprising
(a) a container comprising at least four walls wherein at least two walls are parallel to each other, the container having a distal end, any two adjoining walls defining a frame axis, a plurality of frame axes being parallel to each other, the container having a distal end;
(b) retaining detents incorporated into two opposing parallel walls in equal numbers, oriented to provide slots parallel to a frame axis such that a plurality of slides may be disposed in the slide holder; and
(c) at least one limiting bar placed at the distal end of the slide holder.

8. The slide holder described in claim 7 wherein the slide holder comprises a porous screen at the distal end of the container.

9. A method of labeling a sample comprising
(a) providing a microscope slide holder comprising
(i) a container comprising at least four walls wherein at least two walls are parallel to each other, the container having a distal end, any two adjoining walls defining a frame axis, a plurality of frame axes being parallel to each other, the container having a distal end;
(ii) retaining detents incorporated into two opposing parallel walls in equal numbers, oriented to provide slots parallel to a frame axis such that a plurality of slides may be disposed in the slide holder; and
(iii) at least one limiting bar placed at the distal end of the slide holder.
(b) contacting a sample affixed to a microscope slide with a reagent;
(c) placing the labeled slide in a slot of said slide holder wherein slide holder is positioned such that the slot is oriented essentially horizontally; and
(d) immersing said slide holder in a composition that rinses the reagent from the slide wherein the slide holder is positioned in the composition such that the slot is oriented essentially vertically.

10. A microscope slide holder comprising:
(a) rotatable horizontal shelves held in parallel to one another in a peon housing frame, the rotatable horizontal shelves operatively configured to hold a plurality of microscope slides in a horizontal manner;
(b) actuation means for rotating in tandem said rotatable horizontal shelves from a horizontal plane to a vertical plane within said housing.

11. A solvent mixture for preventing hydrophobic fluorophore precipitation during a dye coupling reactions said solvent mixture comprising acetonitrile and dimethylsulfoxide.
